(19) United States
(12) Patent Application Publication
(10) Pub. No.: US 2012/0142393 A1
(43) Pub. Date: Jun. 7, 2012

(54) METHOD AND APPARATUS FOR CONTROLLING TRANSMISSION POWER IN MOBILE TERMINAL

(75) Inventors: Youn Su WON, Suwon-si (KR); Byung Hwa PARK, Hwaseong-si (KR); Seong Beom HONG, Seoul (KR)

(73) Assignee: Samsung Electronics Co., Ltd., Suwon-si (KR)

(21) Appl. No.: 13/311,902

(22) Filed: Dec. 6, 2011

(30) Foreign Application Priority Data
Dec. 6, 2010 (KR) 10-2010-0123582

(51) Int. Cl. H04W 52/38

(52) U.S. Cl. 455/522

(57) ABSTRACT

A method and an apparatus for controlling transmission power in a mobile terminal are provided. The method includes determining whether a human body touches the mobile terminal, comparing a current transmission power with a preset threshold power, when it is determined that the human body touches the mobile terminal, setting the transmission power to a value lower than the preset threshold power, when the current transmission power is equal to or higher than the preset threshold power, and outputting a signal with the set transmission power.

### PRIORITY

This application claims the benefit under 35 U.S.C. §119(a) of a Korean patent application filed on Dec. 6, 2010 in the Korean Intellectual Property Office and assigned Serial No. 10-2010-0123582, the entire disclosure of which is hereby incorporated by reference.

### BACKGROUND OF THE INVENTION

1. Field of the Invention

The present invention relates to a method and an apparatus for controlling transmission power in a mobile terminal More particularly, the present invention relates to a method for controlling transmission power in a mobile terminal to satisfy a Specific Absorption Rate (SAR) and an apparatus for implementing the same.

2. Description of the Related Art

A Specific Absorption Rate (SAR) expresses a degree as a value by which an electromagnetic wave is absorbed in a human body. The SAR is an electromagnetic absorption power per unit mass absorbed in the human body when a mobile terminal is used. If a measured value of the SAR is greater than a reference value, it may have a negative influence upon the human body. Respective countries regulate the SAR to not exceed the reference value with respect to a head of the human body. In general, because it is difficult to measure the SAR with respect to the human body directly, a test dummy having an electrical constant similar to a body tissue is used to measure SAR. An allowable value of Korean or American SAR is 1.6 mW/g, and an allowable value of European and Japanese SAR is 2.0 mW/g. In recent years, a tablet Personal Computer (PC) having a size larger than that of a mobile terminal has become popular. A user frequently uses a tablet PC by contacting a body part, other than a head. Respective countries regulate the body SAR not to exceed a reference value.

In general, the greater the transmission power, the higher the SAR. A strength of an electromagnetic wave emitted from an antenna using an antenna matching circuit with a high Voltage Standing Wave Ratio (VSWR) is reduced in order to lower the SAR. However, this method increases loss of an optimized antenna matching circuit to deteriorate the efficiency of an antenna itself That is, this method reduces the strength of an emitted electromagnetic wave and deteriorates receiving sensitivity performance, thereby deteriorating transmitting and receiving performances.

Besides this method, there is a method of changing an antenna pattern and a method of changing a ground of a mobile terminal However, these methods have a limitation in lowering the SAR.

### SUMMARY OF THE INVENTION

Aspects of the present invention are to address at least the above-mentioned problems and/or disadvantages and to provide at least the advantages described below. Accordingly, an aspect of the present invention is to provide a method for controlling transmission power in a mobile terminal to satisfy a Specific Absorption Rate (SAR) and an apparatus for implementing the same.

In accordance with an aspect of the present invention, a method for controlling transmission power is provided. The method includes determining whether a human body touches the mobile terminal, comparing a current transmission power with a preset threshold power, when it is determined that the human body touches the mobile terminal, setting the transmission power to a value lower than the preset threshold power, when the current transmission power is equal to or higher than the preset threshold power, and outputting a signal with the set transmission power.

In accordance with an aspect of the present invention, a mobile terminal for controlling transmission power is provided. The mobile terminal includes at least one sensing node disposed at a human body touch area of the mobile terminal, a touch sensor for detecting whether a human body touches the mobile terminal at the at least one sensing node, a transceiver for amplifying and outputting a signal, and for transmitting an output voltage to a controller, a memory for storing a table including transmission powers corresponding to output voltages, and a threshold power, and a controller for detecting an output voltage received from the transceiver when the human body touches the mobile terminal at the touch sensor, for determining a transmission power corresponding to an output voltage from the memory, for comparing the determined transmission power with the threshold power, for setting the transmission power to a value lower than the threshold voltage when the transmission power is equal to or higher than the threshold power, and for controlling the transceiver to output a signal with an output voltage corresponding to the set transmission power.

Aspects of the present invention reduce a SAR while maintaining signal transmitting and receiving performances of a mobile terminal

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal, according to an exemplary embodiment of the present invention;

FIG. 2 is a block diagram illustrating constructions of a Radio Frequency (RF) communication unit and a controller of a mobile terminal, according to an exemplary embodiment of the present invention;

FIG. 3 is a flowchart illustrating a method for controlling transmission power in a mobile terminal when a user touches the mobile terminal, according to an exemplary embodiment of the present invention;

FIG. 4 is a flowchart illustrating a method for controlling transmission power in a mobile terminal when a user discontinues touching the mobile terminal, according to an exemplary embodiment of the present invention;

FIG. 5 is a view illustrating an example of a table applied according to an exemplary embodiment of the present invention; and

FIGS. 6A and 6B are views illustrating examples of a sensing node provided in a mobile terminal, according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A mobile terminal according to exemplary embodiments of the present invention may be a 2^{nd} Generation (2G) terminal such as a Code Division Multiple Access (CDMA) terminal or a Global System for Mobile communication (GSM), a 3^{rd} Generation (3G) terminal such as a Wideband Code Division Multiple Access (WCDMA), a 4^{th} Generation (4G) terminal such as a Long Term Evolution (LTE) terminal, or any other type or generation of terminal In particular, exemplary embodiments of the present invention are applicable to a small portable terminal having a display device smaller than 4 inches, a medium portable terminal having a display device between 4 and 10 inches, and a large portable terminal having a display larger than 10 inches.

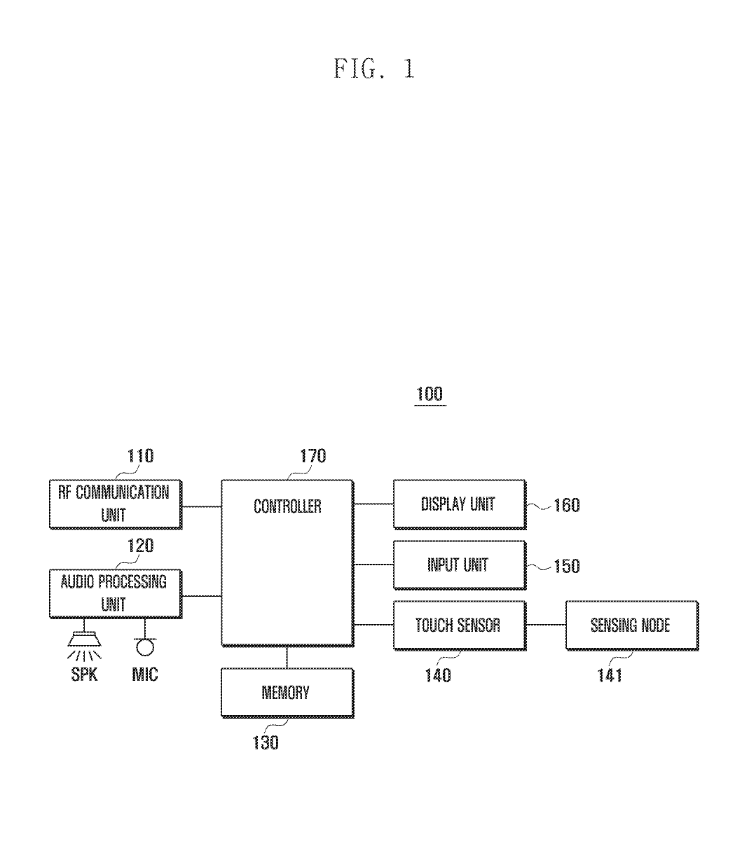

FIG. 1 is a block diagram illustrating a configuration of a mobile terminal, according to an exemplary embodiment of the present invention.

Referring to FIG. 1, the mobile terminal 100 includes a Radio Frequency (RF) communication unit 110, an audio processing unit 120, a memory 130, a touch sensor 140, at least one sensing node 141, an input unit 150, a display unit 160, and a controller 170. According to exemplary embodiments of the present invention, the mobile terminal may include additional and/or different components, or omit any number of the component shown in FIG. 1. Similarly, the functionality of two or more components may be integrated into a single component.

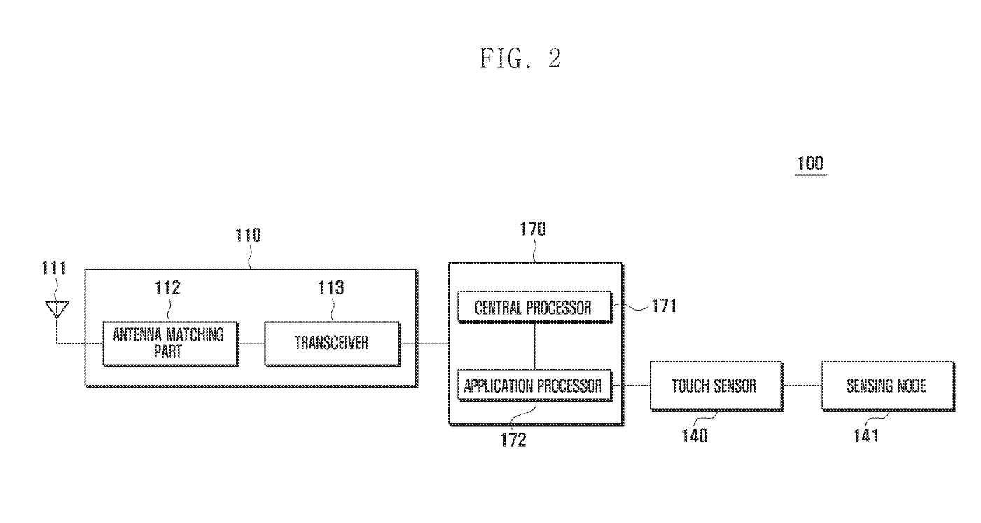

The RF communication unit 110 transmits and receives data for radio communication of the mobile terminal 100. The RF communication unit 110 up-converts a frequency of a transmit signal and amplifies the signal, and low-noise-amplifies a received signal and down-converts the signal. A detailed construction of the RF communication unit 110 is described further below with reference to FIG. 2.

The audio processing unit 120 may be implemented with a CODEC. The CODEC may include a data CODEC for processing packet data and an audio CODEC for processing an audio signal such as speech. The audio processing unit 120 converts a digital audio signal into an analog audio signal through the audio CODEC and plays the analog audio signal through a speaker (SPK). The audio processing unit 120 converts an analog audio signal input from a microphone (MIC) into a digital audio signal.

The memory 130 stores programs and data used for operations of the mobile terminal 100. The memory 130 may be divided into a program area and a data area. The program area may store an Operating System (OS) for controlling an overall operation the mobile terminal 100 and for booting the portable terminal 100, and application programs used for playing multimedia contents or performing other functions of the mobile terminal 100, for example, a camera function, a sound playing function, and an image or moving image playing function. The data area may store data created according to a use of the mobile terminal 100, for example, images, moving images, phone-books, or audio data. The memory 130 may store a table to which an output voltage (V), an Analog Digital Converter (ADC) value, or a transmission power (dBm) is mapped.

The touch sensor 140 senses touch input of a user. The touch sensor 140 is preferably implemented with a capacitive touch sensor, which detects a change in an amount of capacitance. However, the present invention is not limited thereto. The touch sensor 140 may be implemented with a touch sensor such as a resistive overlay type, an infrared beam type, or a pressure sensor. Besides the foregoing sensors, various types of sensor devices capable of sensing a contact or pressure of an object may be used as the touch sensor 140. The touch sensor 140 senses touch input of a user of the mobile terminal 100, and generates and transmits a corresponding sensing signal to the controller 160. Further, the touch sensor 140 senses a body touch discontinuation from the mobile terminal 100, and generates and transmits a corresponding sensing signal to the controller 170. The at least one sensing node 141 is a part where a touch of the user occurs. The touch sensor 140 may detect a human body touching the mobile terminal 100 at the at least one sensing node 141. The touch sensor 140 may be disposed adjacent to an area where an antenna 111 (shown in FIG. 2) of the mobile terminal 100 is located. Further, the at least one sensing node 141 may be formed at one of a front surface, a rear surface, a side surface of the mobile terminal 100, or any combination thereof.

The input unit 150 receives and sends a key operation signal of a user for controlling the mobile terminal 100 to the controller 170. The input unit 150 may be implemented with a keypad such as a 3*4 pad or a QWERTY keypad including a numeral key, a character key, and an arrow key or a touch panel. Besides these, the input unit 150 may be implemented with at least one of a button key, a jog key, and a wheel key. The input unit 150 generates and sends an input signal for executing applications (e.g., a call function, a music playing function, a moving image playing function, an image display function, a camera photographing function, a Digital Multimedia Broadcasting (DMB) broadcasting output function) of the mobile terminal 100 to the controller 170.

The display unit 160 may be implemented with a Liquid Crystal Display (LCD), an Organic Light Emitting Diode (OLED), an Active Matrix Organic Light Emitting Diode (AMOLED), etc. The display unit 160 visibly provides a menu of the mobile terminal 100, input data, function setting information, and various other information. The display unit 160 executes a function outputting a booting screen, an idle screen, a menu screen, a call screen, and other application screens of the mobile terminal 100.

The controller 170 controls an overall operation with respect to respective structural elements of the mobile terminal 100. The controller 170 determines whether a human body touches the mobile terminal 100 through a sensing signal received from a touch sensor 140. The controller 170 detects an output voltage received from an RF communication unit 110, and determines transmission power corresponding to the detected output voltage from a table stored in a memory 130. The controller 170 determines whether the determined transmission power is equal to or higher than a threshold power suited to a Specific Absorption Rate (SAR) standard. When the determined transmission power is equal to or higher than the threshold power, the controller 170 sets the transmission power to a value lower than the threshold power, determines an output voltage corresponding to the set transmission power from the table stored in the memory 130, and sends the determined output voltage to the RF communication unit 110. The controller 170 controls the RF communication 110 to amplify and output a signal corresponding to the determined output voltage.

Further, the controller 170 determines whether an ongoing touch of the mobile terminal 100 by the human body is discontinued, through the sensing signal received from the touch sensor 140. If the touch of the mobile terminal 100 by the human body is discontinued, the controller 170 sets the transmission power to a value corresponding to a value before the transmission power was changed as a result of the human body touching the mobile terminal 100, determines an output voltage corresponding to the set transmission power, and sends the determined output voltage to the RF communication unit 110. The controller 170 controls the RF communication unit 110 to amplify and output a signal to an output voltage corresponding to the transmission power before the transmission power was changed as a result of the human body touching the mobile terminal 100.

The controller 170 is preferably implemented in a multi-chip form including a central processor and an application processor. However, the present invention is not limited thereto. The controller 170 may be implemented with a processor of a one-chip form.

FIG. 2 is a block diagram illustrating constructions of an RF communication unit and a controller of a mobile terminal, according to an exemplary embodiment of the present invention.

Referring to FIG. 2, the RF communication unit 110 includes an antenna 111, an antenna matching part 112, and a transceiver 113. According to exemplary embodiments of the present invention, the RF communication unit 110 may include additional and/or different components, or omit any number of the component shown in FIG. 2. Similarly, the functionality of two or more components may be integrated into a single component.

The antenna 111 efficiently emits an electromagnetic wave for RF communication or efficiently induces an electromotive force corresponding to a received electromagnetic wave, and is coupled with the antenna matching part 112.

The antenna matching part 112 matches the transceiver 113 with the antenna 111.

The transceiver 113 amplifies a signal received from the central processor 171 and transmits the amplified signal to the antenna matching part 112. The transceiver 113 also reduces the amplitude of a signal received from the antenna matching part 112 and transmits the signal to the central processor 171. Upon output of the signal, the transceiver 113 transmits an output voltage to the central processor 171. Further, if the transceiver 113 receives an output voltage from the central processor 171, the transceiver 113 amplifies a signal to output the received output voltage.

The controller 170 includes a central processor 171 and an application processor 172. According to exemplary embodiments of the present invention, the controller 170 may include additional and/or different components, or omit any number of the component shown in FIG. 2. Similarly, the functionality of two or more components may be integrated into a single component.

The central processor 171 is coupled with the transceiver 113 of the RF communication unit 110 and the application processor 172 is coupled with the touch sensor 140. If the application processor 172 receives a touch sensing signal from the touch sensor 140, the application processor 172 sends a signal to the central processor 171 indicating that a human body is touching the mobile terminal 100. If the central processor 171 receives the signal from the application processor 172 indicating that the human body is touching the mobile terminal 100, the central processor 171 detects an output voltage received from the transceiver 113, determines transmission power corresponding to the output voltage from a table stored in the memory 130, and compares the determined transmission power with a threshold power set to satisfy a SAR standard. If a current transmission power is lower than the threshold power, the central processor 171 maintains the current transmission power. If current transmission power is higher than the threshold power, the central processor 171 sets the transmission power to a value lower than the threshold power, determines an output voltage corresponding to the set transmission power, and sends the determined output voltage to the transceiver 113. The central processor 171 sends a control command to the transceiver 113 such that the transceiver 113 outputs a signal with the determined output voltage. The transceiver 113 controls a gain to control the output voltage received from the central processor 171, and amplifies the signal according to the controlled gain.

If the application processor 172 receives a touch discontinuation signal from the touch sensor 140, the application processor 172 informs the central processor 171 of the touch discontinuation. The central processor 171 sets transmission power to a value before the transmission power was change due to the touch of the mobile terminal 100 by the human body, determines an output voltage corresponding to the set transmission power, and sends the determined output voltage to the transceiver 113. The central processor 171 sends a control command to the transceiver 113 such that the transceiver 113 outputs a signal with the determined output voltage. The transceiver 113 controls a gain to control the output voltage received from the central processor 171, and amplifies the signal according to the controlled gain.

The foregoing exemplary embodiment illustrates a configuration of a mobile terminal 100 according to an exemplary embodiment of the present invention. Hereinafter, a method for controlling transmission power of the mobile terminal 100 will be described.

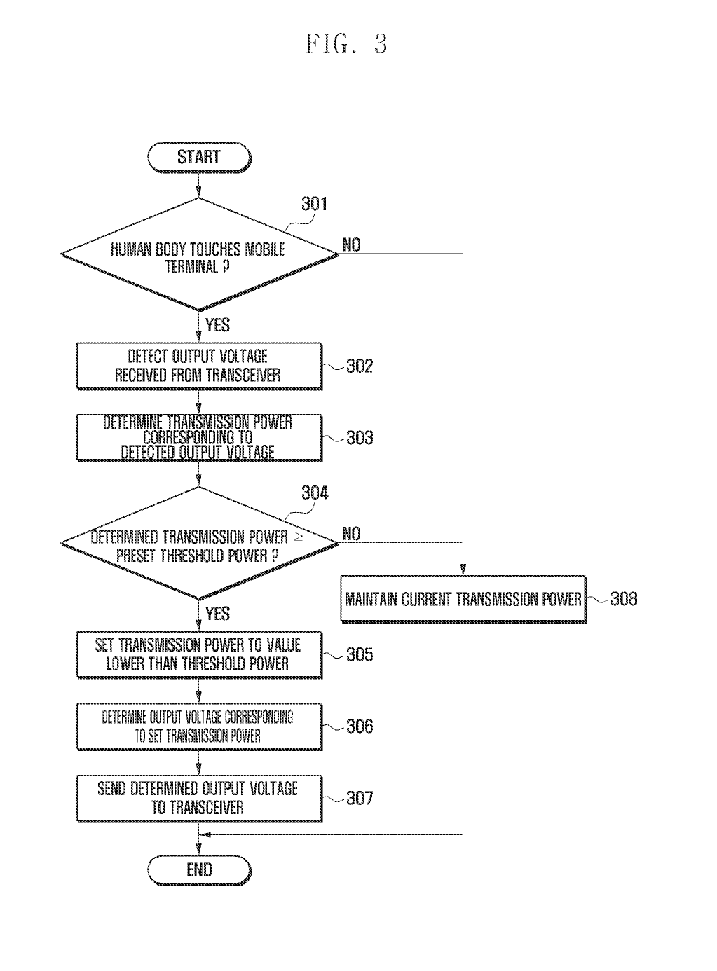

FIG. 3 is a flowchart illustrating a method for controlling transmission power in a mobile terminal when a user touches the mobile terminal, according to an exemplary embodiment of the present invention.

Referring to FIG. 3, a controller 170 determines whether a human body touches a mobile terminal 100 in a state where the mobile terminal 100 is transmitting a signal with a set transmission power in step 301. If the user touches at least one sensing node 141 disposed at a predefined area of the mobile terminal 100, a touch sensor 140 connected to the sensing node 141 senses a user's touch, and generates and sends a touch-sensing signal to an application processor 172. The application processor 172 receives the touch-sensing signal to determine s that the user's touch is input.

The controller 170 detects an output voltage received from a transceiver 113 in step 302. If the application processor 172 determines that the user touch is input, the application processor 172 informs the central processor 171 of the user's touch, and the central processor 171 detects an output voltage received from the transceiver 113.

Next, the controller 170 determines a transmission power corresponding to the detected output voltage in step 303. The central processor 171 determines a transmission power corresponding to the output voltage recognized through a table stored in the memory 130 to which an output voltage (V), an Analog Digital Converter (ADC) value, or transmission power (dBm) is mapped. The table may contain binary converted ADC values of an output voltage and a transmission power. In this case, the central processor 171 determines an ADC value corresponding to the output voltage (V).

The central processor 171 determines whether the determined transmission power is equal to or higher than a preset threshold power in step 304. Since transmission power should not exceed a constant value to satisfy a SAR standard, the central processor 171 sets the highest transmission power capable of satisfying the transmission power as threshold power.

As the determined result at step 304, when the transmission power is equal to or higher than the threshold power, the controller 170 sets the transmission power to a value lower than the threshold power in step 305. The central processor 171 may set the transmission power to a specific value or a constant reduced value. For example, when current transmission power is 24 dBm and threshold power is 22 dBm, the central processor 171 may set the transmission power to 21 dBm, which is lower than 22 dBm. In this case, the central processor 171 previously sets and stores transmission power in the memory 130. Further, the central processor 171 may set the transmission power to 21 dBm obtained by subtracting 3 dBm from current transmission power 24 dBm. If the current transmission power is 23 dBm, the central processor 171 may set the transmission power to 20 dBm obtained by subtracting 3 dBm from 23 dBm. In an exemplary embodiment of the present invention, when the table is implemented with output voltages and ADC values, the central processor 171 may set the ADC value to a value lower than an ADC value corresponding to the threshold power. That is, the central processor 171 may control the ADC value to control an output voltage of the transceiver 113.

Subsequently, the controller 170 determines an output voltage corresponding to the set transmission power in step 306. The central processor 171 determines an output voltage corresponding to newly set transmission power from a table stored in the memory 130. That is, the central processor 171 may determine an ADC value corresponding to the set transmission power to determine an output voltage corresponding to the ADC value.

The controller 170 sends the determined output voltage to a transceiver 113 in step 307. The central processor 171 sends a signal output command to the transceiver 113 together with the determined output voltage. The transceiver 113 controls a gain such that the central processor 171 outputs a signal with the determined output voltage.

When the touch by the human body is not sensed at step 301, the controller 170 maintains the current transmission power in step 308. When the determined transmission power is lower than the preset threshold power at step 304, the controller 170 maintains the current transmission power in step 308.

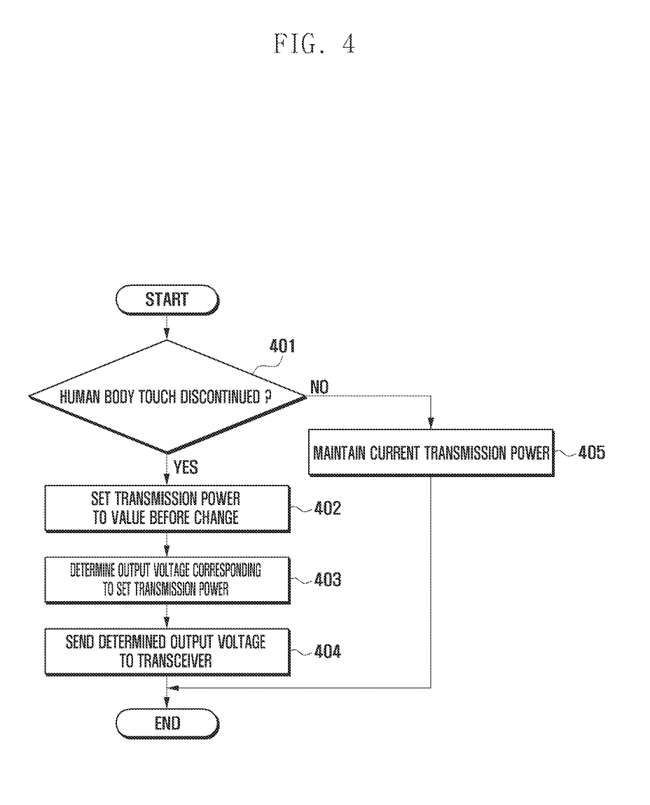

FIG. 4 is a flowchart illustrating a method for controlling transmission power in a mobile terminal when discontinues touching the mobile terminal, according to an exemplary embodiment of the present invention.

Referring to FIG. 4, it is assumed that a user is touching the mobile terminal 100, and the mobile terminal 100 is transmitting a signal with an output voltage that had been changed in response to the touching of the mobile terminal 100 by the user. At this time, the controller 170 determines whether the touch of the mobile terminal 100 by the user is discontinued in step 401. If a user discontinues touching all of the at least one sensing node 141 while the touch thereof has been sensed, a touch sensor 140 connected to the sensing node 141 senses the discontinuation of the touch of the user, and generates and sends a touch discontinuation signal to the application processor 172. The application processor 172 receives the touch discontinuation signal to determine that user touch is discontinued.

The controller 170 sets the transmission power to a value before the change in step 402. If the application processor 172 determines that the user touch is discontinued, the application processor 172 informs the central processor 171 of the discontinuation of the user's touch. If the central processor 171 receives a signal from the application processor 172 indicating that the touch is discontinued, the central processor 171 sets the transmission power to a value before change. That is, the central processor 171 sets the transmission power to a value that was set before the human body touch was sensed at step 301 of FIG. 3. In an exemplary embodiment of the present invention, the central processor 171 may set the transmission power to a certain value other than the value before the change. For example, when the touch discontinuation occurs, the transmission power is set to a value lower than a value before change by 1 dBm. In a case where the value before change is 24 dBm and a changed value is 21 dBm, if the central processor 171 receives a signal from the application processor 172 indicating that the touch discontinuation occurs, the central processor 171 may set the transmission power to 23 dBm obtained by subtracting 1 dBm form the value 24 dBm before the change.

Next, the controller 170 determines an output voltage corresponding to the set transmission power in step 403. The central processor 171 determines an output voltage corresponding to newly set transmission power from a table to which an output voltage, an ADC value, and transmission power are mapped. In an exemplary embodiment of the present invention, when the table is implemented with an output voltage and an ADC value, the central processor 171 may set the ADC value to a value before the change at step 402, and determine an output voltage corresponding to the set ADC value in step 403.

The controller 170 sends the determined output voltage to the transceiver 113 in step 404. The central processor 171 sends a signal output command to the transceiver 113 together with the determined output voltage. The transceiver 113 controls a gain such that the central processor 171 outputs a signal with the determined output voltage.

When the touch of the mobile terminal 100 by the human body is not discontinued, the controller 170 maintains current transmission power in step 405.

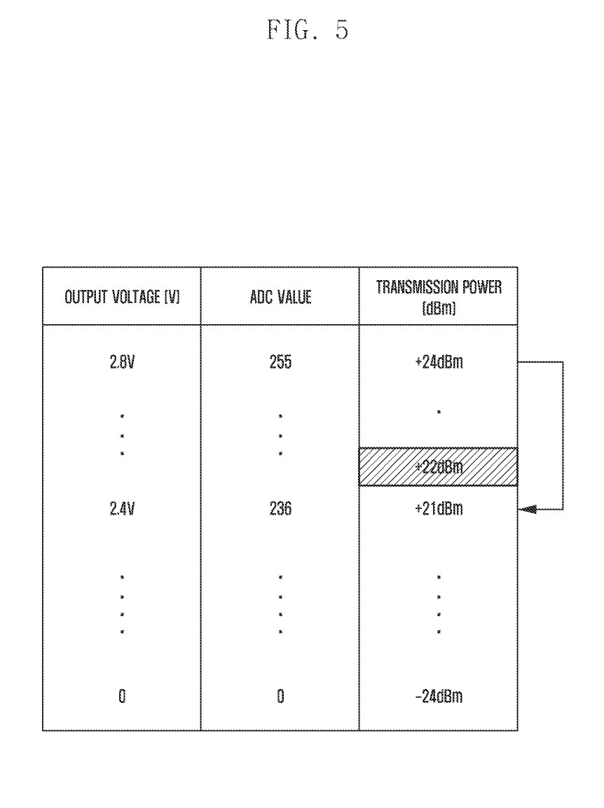

FIG. 5 is a view illustrating an example of a table applied according to an exemplary embodiment of the present invention.

The table is implemented with an output voltage (V), an ADC value, and transmission power (dBm). Referring to FIG. 5, the transmission powers are in the range of −24 dBm to +24 dBm. The ADC values are obtained by converting values ranging from −24 dBm to +24 dBm, and are in the range of 0 to 255. The output voltages are in the range of 0 to 2.8V. Here, it is assumed that the threshold power for satisfying a SAR standard is set to +22 dBm.

In an exemplary embodiment of the present invention, if the central processor 171 receives a signal indicating that a user touches the mobile terminal 100 from the application processor 172, the central processor 171 detects an output voltage received from the transceiver 113. When the output voltage received from the transceiver 113 is 2.8V, the central processor 171 determines an ADC value corresponding to an output value of 2.8V. In FIG. 5, an ADC value corresponding to an output value of 2.8V is 255, and the transmission power corresponding to the ADC value of 255 is +24 dBm. Because threshold power for satisfying the SAR standard is set to +22 dBm, the central processor 171 determines that the transmission power is higher than the threshold power. In this case, the central processor 171 sets the transmission power to a value lower than the threshold power. In an exemplary embodiment of the present invention, certain transmission power, for example, a reduced transmission power may be set in the mobile terminal 100. For example, when +21 dBm is set as the certain transmission power, the central processor 171 sets the transmission power to +21 dBm. Further, when 3 dBm is set as a subtracting transmission power, the central processor 171 sets the transmission power to +21 dBm, which is obtained by subtracting 3 dBm from +24 dBm.

The central processor 171 determines an ADC value 236 corresponding to 21 dBm to determine an output voltage (2.4V) corresponding to the ADC value 236.The central processor 171 sends output information of 2.4V to the transceiver 113 together with a signal output command. The transceiver 113 controls a gain to output a signal with an output voltage of 2.4V.

Further, if the central processor 171 receives a signal indicating that a user discontinues the touch of the mobile terminal 100, the central processor 171 sets the transmission power to a value before the change. Because the transmission power before the change is +24 dBm, the central processor 171 again sets the transmission power to +24 dBm. In an exemplary embodiment of the present invention, the central processor 171 may set the transmission power to +23 dBm, which is obtained by subtracting 1 dBm from +24 dBm. Subsequently, the central processor 171 determines an ADC value 255 corresponding to transmission power of +24 dBm to determine an output voltage of 2.8V corresponding to the ADC value 255. The central processor 171 sends output information of 2.8V to the transceiver 113 together with a signal output command. The transceiver 113 controls a gain to output a signal with an output voltage of 2.8V.

In an exemplary embodiment of the present invention, the table may be implemented with a gain and transmission power mapped thereto. In this case, if the central processor 171 receives a currently amplified gain from the transceiver 113, it determines the transmission power corresponding to the gain, and compares the determined transmission power with a threshold power for satisfying a SAR standard. If the current transmission power is higher than the threshold power, the central processor 171 sets the transmission power to a value lower than the threshold power, and determines and sends a gain corresponding to the set transmission power to the transceiver 113. The transceiver 113 amplifies and outputs a voltage with the gain received from the central processor 171.

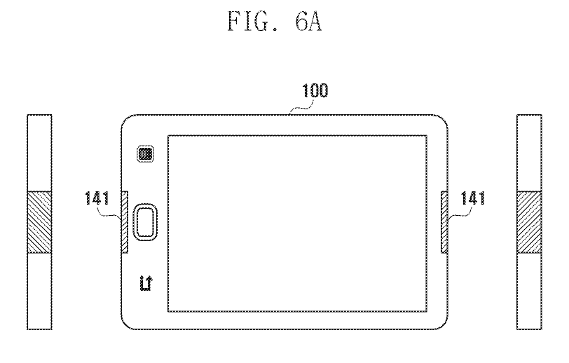

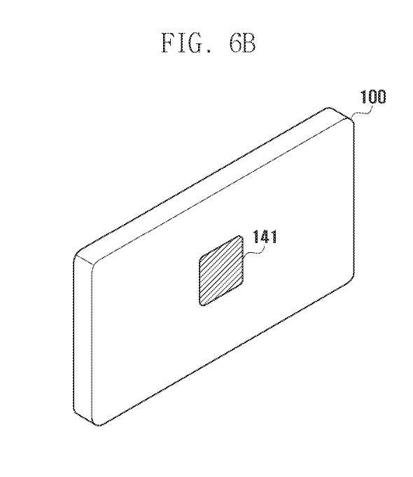

FIGS. 6A and 6B are views illustrating examples of a sensing node provided in the mobile terminal, according to an exemplary embodiment of the present invention.

Referring to FIG. 6A, a front surface and sides of the mobile terminal 100 are shown, and sensing nodes 141 are disposed at the sides of the mobile terminal 100.

In a case of a mobile terminal 100 having a display device larger than 7 inches, because a user frequently holds and uses the mobile terminal 100 with both hands, the sensing nodes 141 may be disposed at the sides of the mobile terminal 100 to determine whether a human body touches the mobile terminal 100.

More specifically, FIG. 6A shows two sensing nodes 141 provided at two of four sides of the mobile terminal 100 which have relatively small areas. However, the present invention is not limited thereto. The sensing nodes 141 may be provided at all of four sides, or two sides having relatively large areas, respectively.

Referring to FIG. 6B, a rear surface of a mobile terminal is shown, and a sensing node 141 is provided at the rear surface of the mobile terminal 100. Since a user may position and use the mobile terminal 100 with a large display device on a knee or a leg, the sensing node 141 may be provided at a rear surface of the mobile terminal 100 to determine whether the human body touches the mobile terminal 100. FIG. 6B shows one sensing node 141 provided at a rear surface of the mobile terminal 100. However, the present invention is not limited thereto. Two sensing nodes 141 may be provided at the rear surface of the mobile terminal 100. Meanwhile, FIG. 6B shows a sensing node 141 provided at a center of a rear surface of the mobile terminal 100. However, the present invention is not limited thereto. The sensing node 141 may be provided at edges of the rear surface of the mobile terminal 100.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling transmission power of a mobile terminal, the method comprising:
determining whether a human body touches the mobile terminal;
comparing a current transmission power with a preset threshold power, when it is determined that the human body touches the mobile terminal;
setting the transmission power to a value lower than the preset threshold power, when the current transmission power is equal to or higher than the preset threshold power; and
outputting a signal with the set transmission power.

2. The method of claim 1, wherein the threshold power is a value set for satisfying a Specific Absorption Rate (SAR).

3. The method of claim 1, wherein the determining of whether the human body touches the mobile terminal comprises determining whether the human body touches a sensing node disposed at a predefined area of the mobile terminal.

4. The method of claim 1, wherein the comparing of the current transmission power with the preset threshold power comprises:
detecting an output voltage received from a transceiver of the mobile terminal when it is determined that the human body touches the mobile terminal;
determining a transmission power corresponding to the detected output voltage; and
comparing the determined transmission power with the preset threshold power.

5. The method of claim 4, wherein the setting of the transmission power comprises setting the transmission power to a value obtained by subtracting a preset value from the determined transmission power.

6. The method of claim 4, wherein the outputting of the signal comprises:
determining an output voltage corresponding to the set transmission power;
sending the determined output voltage to the transceiver; and
amplifying a voltage of the signal to the sent output voltage to output the signal by the transceiver.

7. The method of claim 1, further comprising maintaining the current transmission power when it is determined that the human body does not touch the mobile terminal.

8. The method of claim 1, further comprising maintaining the current transmission power when the current transmission power is lower than the threshold power.

9. The method of claim 1, further comprising:
determining whether the human body discontinues touching the mobile terminal;
setting the transmitting power to a value before the human body touched the mobile terminal; and
outputting the signal with the set transmission power.

10. The method of claim 4, wherein the determining of the transmission power comprises:
determining an Analog Digital Converter (ADC) value corresponding to the detected output voltage; and
determining a transmission power corresponding to the determined ADC value.

11. A mobile terminal comprising:
at least one sensing node disposed at a human body touch area of the mobile terminal;
a touch sensor for detecting whether a human body touches the mobile terminal at the at least one sensing node;
a transceiver for amplifying and outputting a signal, and for transmitting an output voltage to a controller;
a memory for storing a table including transmission powers corresponding to output voltages, and a threshold power; and
a controller for detecting an output voltage received from the transceiver when the human body touches the mobile terminal at the touch sensor, for determining a transmission power corresponding to an output voltage from the memory, for comparing the determined transmission power with the threshold power, for setting the transmission power to a value lower than the threshold voltage when the transmission power is equal to or higher than the threshold power, and for controlling the transceiver to output a signal with an output voltage corresponding to the set transmission power.

12. The mobile terminal of claim 11, wherein the controller comprises:
an application processor for receiving a human body touch sensing signal from the touch sensor and for sending a signal indicating that the human body touches the mobile terminal to a central processor; and
the central processor for detecting the output voltage from the transceiver when a signal indicating that the human body is touching the mobile terminal is received from the application processor, for determining the transmission power corresponding to the output voltage from the memory, for comparing the determined transmission power with the threshold power, for setting the transmission power to a value lower than the threshold power when the transmission power is equal to or higher than the threshold power, and for controlling the transceiver to output the signal with the output voltage corresponding to the set transmission power.

13. The mobile terminal of claim 11, wherein the at least one sensing node comprises two sensing nodes disposed at two sides of the mobile terminal.

14. The mobile terminal of claim 11, wherein the sensing node is disposed at a rear surface of the mobile terminal.

15. The mobile terminal of claim 11, wherein the threshold power is a value for satisfying a Specific Absorption Rate (SAR).

16. The mobile terminal of claim 11, wherein the central processor sets the transmission power to a value obtained by subtracting a preset value from the determined transmission power.

17. The mobile terminal of claim 11, wherein the central processor maintains a current transmission power when the human body does not touch the mobile terminal.

18. The mobile terminal of claim 11, wherein the central processor maintains the current transmission power when the current transmission power is lower than the threshold power.

19. The mobile terminal of claim 11, wherein the central processor determines whether the human body discontinues touching the mobile terminal, and
wherein, when the central processor determines that the human body discontinues touching the mobile terminal, sets the transmitting power to a value before the human body touched the mobile terminal, and controls the transceiver to output the signal with the set transmission power.
